(19) United States
(12) Patent Application Publication
(10) Pub. No.: US 2010/0119681 A1
(43) Pub. Date: May 13, 2010

(54) DIETARY SUPPLEMENT AND METHOD FOR PRODUCING THE SAME

(75) Inventor: Toru Yumita, Kanagawa-ken (JP)

Correspondence Address: BACON & THOMAS, PLLC, 625 SLATERS LANE, FOURTH FLOOR, ALEXANDRIA, VA, 22314-1176, US

(73) Assignee: IL PLEUT SUR LA SEINE KIKAKU CO., LTD., Tokyo (JP)

(21) Appl. No.: 12/593,802

(22) PCT Filed: Mar. 19, 2008
(86) PCT No.: PCT/JP2008/055047

§ 371 Date: Sep. 29, 2009

(30) Foreign Application Priority Data
Apr. 4, 2007 (JP) 2007-098824

(51) Int. Cl. A21D 2/38; A21D 2/34

(52) U.S. Cl. 426/549; 426/648

(57) ABSTRACT

The present invention gives effects on maintenance and so on of physical health and can be readily ingested for a long period by anyone. The present invention comprises at least whole fish (dried sardine), seed, rock salt, olive oil, and soybean paste, to be produced in a powder form, in a paste form, or the like. It further comprises either a wheat whole grain or a rye whole grain or both to be produced as cookies. About 30 to 60 wt. % either a wheat whole grain or a rye whole grain or both, about 1 to 2 wt. % whole fish, about 8 to 28 wt % seed, about 0.6 to 1.2 wt. % natural salt, about 5 to 12 wt. % olive oil, and about 7 to 16 wt. % soybean paste are preferably mixed. The seed preferably includes almond powder, pine nuts, walnuts, chopped almonds, and white sesame.

### TECHNICAL FIELD

The present invention relates to a dietary supplement that gives effects on maintenance/improvement of human and pet health and that can be readily eaten by anyone and a method for producing the same.

### BACKGROUND ART

Recently, various kinds of dietary supplements are available to consumers. Examples of these are Patent Documents 1, 2, etc. Patent Document 1 discloses a cereal supplement in which a dry grain that has absorbed an aqueous solution of calcium and an essence of a Chinese medicine is heated. Patent Document 2 is based on adding a prescribed amount of a liquid containing an ionized mineral to a vitamin-containing main material to obtain a supplement bonded with the ionized mineral and is a supplement obtained by incorporating a powdery main material containing a vitamin with a liquid containing 0.1-50.0 wt. % ionized mineral, finely dividing the mixture, kneading the finely divided main material with an oil, and sealing the obtained viscous mixture in a capsule.
Patent Document 1: Japanese Patent Application Public Disclosure No. 2004-8120
Patent Document 2: Japanese Patent Application Public Disclosure No. 2005-41851

### DISCLOSURE OF THE INVENTION

### Problems to be Solved by the Invention

Most of the aforementioned conventional supplements are produced by specializing in a few components of specific kinds such as calcium, vitamins, etc., and a supplement produced so as to contain many kinds of nutrients comprehensively has not been found yet. A supplement considering comprehensive nutrition contributing to life maintenance and development has not been found yet.

Also, when many kinds of nutrients are simply mixed to obtain a supplement, each nutrient cannot be absorbed effectively, and the supplement smells very strong and is hard to eat.

The present invention has been made to solve the foregoing problems, and an object of the present invention is to provide a dietary supplement that gives effects on maintenance/improvement of human health and that can be readily eaten by anyone and a method for producing the same.

### Means to Solve the Problems

A dietary supplement according to the present invention is made to solve the aforementioned problems and comprises at least whole fish, seed, natural salt, olive oil, and soybean paste to be produced in a powder form, in a paste form, or as a solid. By containing each of the above ingredients based on these, a dietary supplement is produced in accordance with application.

### EFFECT OF THE INVENTION

The dietary supplement according to the present invention gives effects on maintenance/improvement of physical health and can be readily ingested for a long period by anyone. It can also be used as pet food.

### BRIEF DESCRIPTION OF THE DRAWINGS

FIG. 1 is a perspective view showing a cookie according to an embodiment of the present invention.

### EXPLANATIONS OF REFERENCE NUMERALS

1 cookie

### BEST MODE FOR CARRYING OUT THE INVENTION

Hereinafter, a dietary supplement according to an embodiment of the present invention will be described.

Currently in Japan, diseases such as atopic dermatitis, pollinosis, allergia, endometriosis, and ulcerative colitis are widespread. Under such circumstances, as a result of consideration based on many years of experience in the food field, the present inventor has thought these are caused mainly by a severe lack of micronutrients ingested from foods and dishes. The present inventor has thought this is because a variety of rich micronutrients required by cells, each of which is a minimum unit of a body, are not supplied sufficiently due to the severe lack of micronutrients ingested from foods and dishes, and thus various cells of the body are lacking in their essential roles and functions. A dietary supplement (supplement food) according to the present embodiment is based on these aspects and is made in view of how the rich micronutrients are supplied to the cells. The dietary supplement according to the present embodiment is in a cookie shape.

Here, micronutrients is a collective term of essential nutrients that do not need to be ingested in large amounts but need to be ingested every day in small amounts, such as minerals (mineral substances), vitamins (organic substances), and so on.

In old Japanese households, dried sardine was surely put in a soybean paste soup at breakfast and dinner. Dried sardine, made by boiling and drying whole coarse fish without removing their heads and guts, is an ingredient with rich micronutrients. The old-time children seem to have been filled with vigor more than the present children. I think dried sardine is an excellent ingredient thanks to the wisdom given by Japanese predecessors.

Human beings originate from life generated in the sea. It was changed from a unicellular organism such as ameba to a multicellular organism, gradually evolved via a fish-like state into an amphibian to get ashore, and further evolved into a mammal. This is referred to as systematical generation, and in a human body, life is continuously changed in the process from the fertilization to the repeated cell divisions while the shapes in the past evolutional stages are reproduced and grows up into a human baby. Such a process in which life grows up via the shapes of a fish, an amphibian, etc. into a human baby when a human baby is born shows that, in the present human beings as well, the physical characteristics since life is generated in the earth are taken over on a genetic level. Accordingly, I think little fish or the like that were ingested in the periods of a fish and an amphibian can be an important nutrient for the present human beings as well. That is, I think the fundamental micronutrients required by the present human beings may exactly correspond to micronutrients possessed by a whole fish. A whole little fish abundantly contains a variety of micronutrients such as calcium, iron, vitamins, DHA, EPA, peptide, etc. Since dried sardine is made by boiling and drying whole little fish, the nutrients possessed by little fish can be ingested as they are. It is to be noted that a whole fish may be a little fish or a big fish, and it is important to ingest a whole fish including all from a head through a gut as it is.

Based on these thoughts, the main of the micronutrients of the dietary supplement according to the present embodiment has been dried sardine. With the micronutrients of the dried sardine as a main pillar, micronutrients of various kinds of seed and so on have been mixed. The various kinds of seed contain a sufficient amount of more important fundamental micronutrients to pass life onto the next generation. Also, natural salt (preferably rock salt) containing rich minerals has been added to them. In the present human body, the ratio of minerals to body fluid in which cells flow is said to be approximately equivalent to that to seawater when life was born on the earth. Some kinds of rock salt obtained in various parts of the world contain minerals at a ratio close to that in the seawater.

Also, plural kinds of cheeses have been added, in which milk abundantly containing fundamental micronutrients needed for life maintenance that have been required in the life's long footsteps as mammals is subject to lactic acid fermentation to further broaden the variety of nutrients.

Based on such unprecedented thoughts, cookies originating from a combination of the following ingredients have been proposed.

As ingredients of the cookies of the present embodiment, a wheat whole grain, dried sardine powder, seed (almonds, pine nuts, walnuts, sesame, etc.), rock salt, honey, olive oil, soybean paste, and cheeses (Hard cheeses, fermented more complexly, such as Edam cheese and Gruyere cheese, are preferred. Other kinds of cheeses made in Europe may be used.) were used. Meanwhile, the dried sardine was used because it was easy to use as whole fish. Each fish may be a bigger fish as long as it is a whole fish including a head, a gut, etc.

The reasons and basic thoughts for using such ingredients are as follows.

1) I considered how a variety of rich micronutrients are contained in the cookies with a central focus on fundamental micronutrients required for life maintenance and development required by cells constituting a body of a human being, which was once in a fish shape and now exists as a mammal.

2) I also considered how the micronutrients contained in these ingredients are put in the cookies without missing or destroying them.

3) I considered how efficiently the micronutrients put in the cookies can be digested and absorbed.

4) I considered how these things are cooked by original confectionary production techniques and are given good taste.

About the aforementioned 1):

The ingredients used for the cookies were selected based on the following thoughts.

[1] Seed is an ingredient that has been taken over continuously by the human beings since the primitive age as is apparent from the fact that nuts are discovered, e.g., in Sannai-Maruyama Site and contains more fundamental micronutrients to pass life onto the next generation. Thus, pine nuts, walnuts, almonds, and sesame were added. It is to be noted that pine nuts, almonds, and sesame made in Spain were used, and that walnuts made in France were used. Other kinds of seed may be further added to them.

Among these seed kinds, almonds harvested at a low-rainfall inland in Spain seem to contain extremely rich fundamental micronutrients. These almonds are powerful enough to give effects of curing skin roughness, curing stomatitis, etc. in a short period when they are chopped and added to a bowl of rice or a simmered dish. The almonds made in Spain are essential among the seed kinds.

[2] Selection of salt is important. From the present inventor's experience, I think it is rock salt made in Mongolia that contains abundant minerals most required by Japanese cells. Thus, rock salt made in Mongolia was selected and added as one of the ingredients of the cookies. While chemically refined salt consisting only of NaCl damages the cells, the rock salt made in Mongolia abundantly containing ideal micronutrients has no such worries and is an important source of minerals. Also, minerals in the natural salt act to bring out the taste of the ingredients.

Also, salt must be added sufficiently. The amount of salt to be added directly is small, but when salt contained in the soybean paste and the cheeses is added as well, the amount of salt is quite large, and the cookies taste salty. The amount of salt is important. Currently, salt is thought to damage persons' health, but the present inventor thinks this is totally wrong. The ratio of minerals to body fluid in which cells soak is said to be equal to that to seawater. Accordingly, I think natural salt having the same components as those of seawater does not damage a human body. Although chemically refined salt consisting only of NaCl may be harmful, natural salt having the same components as those of seawater has little possibility to damage a human body since it has the same components as those of body fluid. Further, a human body has a function to discharge more vitamins and minerals ingested than necessary to the outside of the body. Since the same function works in terms of salt, the amount of salt causes no problem, and thus a sufficient amount of salt needs to be added.

Also, I think salt plays a role of a catalyst that facilitates an efficient chemical reaction among the micronutrients. For example, I am sure from my experience that, without sufficient salt, the micronutrients will not be absorbed efficiently in a body even when the micronutrients are abundant. I see many people who continued to ingest sufficient rock salt in accordance with recipes in the present inventor's book, “Rice and Side Dish Renaissance,” improved their metabolism rather than swelling their bodies, had no more swollen bodies, and slimmed down their faces and bodies.

[3] Olive oil was added instead of butter. Normally, butter is added to the cookie dough, but I think butter fat, which is saturated fatty acid, does not agree with Japanese bodies and added olive oil. The dough was made by adding the olive oil and was baked. While butter is animal fat, olive oil is vegetable fat. Also, olive oil abundantly contains minor components that give effects on a human body. That is, olive oil abundantly contains active components such as squalene, vitamin A, vitamin E, polyphenol, chlorophyll, and oleic acid. From my experience, the present inventor used olive oil made in Spain, which seems to contain micronutrients most abundantly.

[4] Further, dried sardine, dried bonito, and soybean paste were added, which are the wisdom in food brought down by Japanese predecessors. As described above, human beings come to the present after the evolutional stage of fish in the sea. Thus, I think dried sardine almost contains fundamental micronutrients required by the cells of the present human beings. Dried sardine made in Japan was used. The heads and the guts were included. Dried sardine in the form of small fish was used. It is to be noted that dried sardine made in foreign countries may be used as long as it is a similar thing.

Also, soybean paste is one in which components such as soybean protein have been changed by the food chain of lactic acid bacteria, yeast, etc. to broaden the variety of micronutrients and abundantly contains fundamental micronutrients. Soybean paste made in Japan was used. Also, dried bonito is one that has broadened the variety of micronutrients by fermentation, and dried bonito made in Japan was used as a matter of course.

Also, cheese was added since it is also one into which the milk protein has been richly changed and abundantly contains fundamental micronutrients for mammals. Cheeses made in the Netherlands and France were used. Honey was added since it seems to contain extremely abundantly fundamental and important micronutrients for nurturing of larvae, energy for a queen bee to continue to lay eggs, and birth of life. Honey made in France was used. Also, dried fig is one in which various micronutrients are changed in the drying process to broaden its variety. Moreover, fig is one of the few fruits whose flesh and seed, or entirety, can be ingested and seems to have an extremely wide variety of micronutrients. Fig made in Turkey was used.

[5] Although many Japanese still think vaguely that ingredients made in Japan are wonderful, it is clear from various data that this is not true. Public data also shows various ingredients significantly lack micronutrients as compared to the past. The present inventor thinks the actual degree of lack is more serious than the data shows.

Then, from the present inventor's experience, that is, the present inventor's nearly forty-year-long experience of dealing in European ingredients and so on, I carefully selected ingredients containing ideal micronutrients more abundantly and produced the cookies. In particular, Japanese products lacking micronutrients were not used except soybean paste, dried bonito, and dried sardine, and ingredients made in foreign countries containing sufficient micronutrients were used as described above.

About 2):

[1] Normal supplements are made by crushing and breaking down various ingredients and extracting portions. The disadvantage of this case is that many minerals and vitamins are even destroyed and lost in the extraction process.

To overcome this, I put the ingredients in the cookies as they were without going over them. For example, pine nuts, almonds, dried sardine, and so on were added as they were or were finely ground slightly so as not to increase damage caused by frictional heat.

[2] Normal supplements are capsuled, or are packed such as green juice. The disadvantage of this case is that vitamins are destroyed by high-temperature sterilization and heating under high pressure.

To overcome this, I put the ingredients in the cookies as they were without going over them.

About 3):

[1] The components of the various ingredients should be made to be digested and absorbed readily by utilizing natural powers. In particular, olive oil and soybean paste were utilized.

Olive oil not only contains rich micronutrients in itself but also has an extremely strong power to resolve components of other ingredients. Thus, olive oil was added to the ingredients to make the cookie dough and was left at a cold place overnight so that the components of the other ingredients may be easily absorbed. Also, olive oil has a function to promote digestion and absorption. That is, bile made in the liver is used for digestion and absorption of dietary nutrients, and the bile is sent from the bile duct to the duodenum by the gallbladder. Olive oil is said to stimulate movement of the gallbladder and the bile duct to promote digestion and absorption.

Soybean paste shall be added similarly to olive oil since it also contains rich micronutrients in itself and seems to resolve the components of the other ingredients to bring a state of being easily absorbed from the present inventor's experience. As one actual example, an example of two women diagnosed as endometriosis is explained. One out of the two women eats dried sardine as it is on a daily basis but does not recover from the illness at all. The other woman, who had been told that operation was required, ate a soybean paste soup including dried sardine in accordance with the present inventor's book, “Rice and Side Dish Renaissance,” and recovered to a state of not requiring operation at all in about two months of starting eating. This may be because the soybean paste soup let the components of dried sardine absorbed easily.

[2] Cooking heating, which is a people's daily routine, shall be done. [a] For example, retort-packed “green juice” undergoes heat treatment under high temperature, high pressure, and a temperature of 100° C. or higher to enhance the preservative quality. This will destroy many vitamins, and natural resolution and absorption will not be done. [b] Normally, capsuled or pill-formed things by extraction of various things have poor efficiency of digestion and absorption. For example, when a commercially-available vitamin supplement is taken, urine gets yellow after about one hour, and many micronutrients contained in the vitamin supplement are excreted in urine.

To avoid these, I produced dietary supplements by “baking,” which is a normal cooking method. That is, they were baked as cookies in the oven in a simple manner. Baking in the oven hardly destroys the micronutrients and brings about positive component changes by appropriate heating.

The cooking method, baking, is one that the human beings have been done in their daily lives continuously for a long period in human history, and the human bodies adapt to it. That is, since the bodily organs are accustomed and changed so as to adapt to component changes of ingredients by baking, digestion and absorption are done naturally and efficiently.

[3] Ingredients that agree with Japanese past dietary habits shall be selected. That is, dried bonito, soybean paste, and dried sardine shall be added to mix ingredients that agree with Japanese bodies especially for more efficient absorption.

About 4):

In the first trial production of the cookies, they did not meet the tastes of people who ate them as they smelled strong and too rough and tasted too rough, but by the technique based on the present inventor's nearly forty-year-long experience of French confectionery production, the tastes were unified, and good taste was successfully given to the cookies. In particular, the cookies were produced in the following manner.

The basic thoughts for production of the cookies are as follows.

Although “Ishoku Dougen (You are what you eat.)” is often said, healthcare professionals seem to be less interested in food from my understanding. There is a tendency of thinking that a disease is developed by genes, and that medicine will cure it. The object to be diagnosed by each doctor is segmented more than ever, and extremely small segmentism seems to be dominant, in which each doctor only takes care of symptoms in the range assigned to himself/herself and may injure other parts as long as he/she cures the symptoms in the range assigned to himself/herself. The doctors cannot see a disease based on the fact that a whole body is an organically connected thing.

Also, they forget the fact apparent to anyone that a body of a creature is built up by micronutrients contained in food changing their shapes. Further, they forget the fact that tissues once formed can maintain their original functions by regenerating new cells constantly with use of micronutrients supplied constantly.

Also, in the present nutrition science, one mistakenly thinks he/she already fully knows the too-much elaborate and complicated body structure by fiddling around with extremely restricted specific micronutrients known by contemporary people.

He/she does not know that there are very few things that people have ever known in the science, and that there are far more things that people have not known yet.

The cookies are based on the thoughts of organically connecting a human body broken into pieces by the medical science. The cookies are based on the thoughts of supplying micronutrients to all cells sufficiently to activate the various cells and recover their original functions.

The cookies are based on the thoughts of connecting the respective cells organically to one another to create energy immunity that a body originally possesses enough to dispense with medicine.

Also, the cookies are based on the thoughts of stopping a fragmentary analysis that is based on extremely restricted nutrients, finding micronutrients contained in food based on the good taste sense by the human DNA, and enriching them.

a) Before starting a trial production, the following points were clarified.

1. It is impossible in terms of the amount to be ingested that the cookies cover all elements such as fat, carbohydrate, etc. of the energy source required for human daily meals, and without being weighted toward specific components, as broad and various micronutrients as possible shall be prepared.

2. The cookies are just supplementary, and ideal daily home-cooked dishes shall be a prerequisite. The object is to supplement micronutrients that cannot be covered or are insufficient in terms of the amount by the daily home-cooked dishes.

3. The basis of the human dietary life is at-home meals, and happy gathering, conversation, and enjoyment of eating delicious dishes together in the meals strengthen a family unity and encourage personal gentleness and growth. However, currently in Japan, micronutrients cannot be supplied sufficiently due to various reasons such as lack of micronutrients from ingredients such as vegetables. Even if a housewife cooks daily dishes full-heartedly, micronutrients required by a human body or cells cannot be supplied sufficiently due to various reasons. The object of producing the cookies is to cover this lacking portion actively.

b) Repeated improvement in the trial production

In the first trial production, I thought a larger amount of dried sardine, which is the center of the combination of the micronutrients, should be added. However, when too much dried sardine was added, the cookies smelled very strong and were evaluated poorly in terms of the taste.

I thought ingredients other than dried sardine should be added sufficiently to the cookie supplements on the premise in part that dried sardine should be ingested in daily meals as well, and the amount of dried sardine powder was halved to restrict the smell. Also, the amount of soybean paste was increased to hide the smell of dried sardine and enrich the flavor and taste.

Also, what has an influence on the teeth sensation of the cookies is the ratio of water to powder. Water must be added to make powder clump together, but when too much water is added, protein in the flour will be coupled with water, gluten will be formed excessively, and the teeth sensation will be too hard. Also, the cookies will be melted in the mouse poorly.

Thus, I attempted to make the dough clump together firmly with as a minimal amount of water as possible. To reduce the amount of water as much as possible, I introduced a method of scattering water on the powder by a ladle or the like little by little and mixing them.

In this case, to make the dough clump together firmly, it is better in terms of operability to grind all seed together by a food processor and add them in a powder state, but they were kept large on purpose to give enjoyment to the teeth sensation and taste. As for almonds, powdered ones and chopped ones into small grains were added to give variety to the teeth sensation.

Also, to alleviate the smell of dried sardine, dried bonito, and so on, and change it into a delicious smell, spices such as cinnamon, nutmeg, etc. were added. Also, according to the present inventor's experience, cinnamon works as a natural strong antioxidant substance, and thus I put it in consideration of its role as an antioxidant substance as well.

The final taste was adjusted by the present inventor's technique and taste sense based on my long experience of French confectionary production.

Normally, most of the supplement foods taste as dry as dust with their taste almost not taken into consideration, and in this case, people will be tired of the dry taste and cannot continue to eat them. Thus, I gave good taste to the cookies although they were dietary supplements so that people could enjoy eating them daily and continue to eat them easily.

In addition, the cookies can be ingested with no problems as nibbles with alcoholic beverages such as beer and wine, they go well with alcoholic beverages in view of their ingredients, and people can have a great time ingesting micronutrients.

Regarding the above four points as pillars of thoughts on the dietary supplements according to the present embodiment, and based on these thoughts, I produced the cookies as the dietary supplements of the present embodiment in the following procedures.

The percentages of the ingredients used are as follows.

I used 3600 g of either a wheat whole grain or a rye whole grain or both (34.18 wt. %), 120 g of dried sardine powder (1.14 wt. %), 120 g of dried bonito thick flakes (1.14 wt. %), 2400 g of seed (22.8 wt. %) [480 g of almond powder (4.56 wt. %), 480 g of pine nuts (4.56 wt. %), 480 g of walnuts (4.56 wt. %), 480 g of chopped almonds (4.56 wt. %), and 480 g of white sesame (4.56 wt. %)], 72 g of rock salt (0.68 wt. %), 720 g of grained Edam cheese (6.84 wt. %), 360 g of grated Gruyere cheese (3.42 wt. %), 960 g of olive oil (9.12 wt. %), 960 g of soybean paste (9.12 wt. %), 840 g of water (7.98 wt. %), 360 g of honey (3.42 wt. %), 7.2 g of cinnamon (0.07 wt. %), and 12 g of nutmeg (0.11 wt. %). The total weight of these ingredients was 10531.2 g, and I produced the cookies in the following procedures with use of these. It is to be noted that, as for cheese, other kind of cheeses made in Europe may be added in addition to the aforementioned grained Edam cheese and so on. Also, other kinds of flavors may be added along with changes in the mixing ratio or ingredients. Further, a small amount of cordyceps sinensis and reindeer horn, which are said to be effective in energy recovery, may be added. Also, a small amount of dried fresh water clams and livers of healthy cows and pigs, which are said to recover impaired liver function, may be added.

1) Dissolve a whole amount of the aforementioned rock salt and soybean paste in a whole amount of the aforementioned water and olive oil, and mix them.

2) Finely grind dried sardine by a food processor.

3) Put all the rye whole grain in a bowl, put all the ingredients except the ingredients in the above step 1 in this bowl, and mix them well.

4) Scatter ⅕ of the whole amount of the water, olive oil, rock salt, and soybean paste mixed in the above step 1 on the ingredients in the bowl mixed in the above step 3 by a spoon or a ladle as evenly as possible.

5) Next, mix the powder having absorbed the water and olive oil while crumbling it in the fingers.

6) Next, flatten the surface, scatter ⅕ of the whole amount of the water, olive oil, rock salt, and soybean paste mixed in the above step 1 again, and mix it in a similar manner to that in the above step 5.

7) Repeat this three more times to mix the whole amount of the water, olive oil, rock salt, and soybean paste mixed in the above step 1.

8) When the whole amount of the water and powder is mixed, a ball consisting of water and powder is gradually made. Clump it together into a big ball only by the hands' pressure.

9) Press it into a metal frame (height: 40 cm, width: 60 cm, depth: 4.5 cm) on a spread plastic sheet so as not to leave space therein while adding it little by little.

10) When everything is put, press the surface strongly by a rolling pin to flatten it.

11) Leave it in the refrigerator at a temperature of 5° C. or lower overnight to harden it firmly.

12) On the following day, cut it into 4.5-cm rods in width first, and then cut them into 5-mm pieces in thickness.

13) Arrange them on a sheet pan with an about 5-mm space in between.

14) Next, put it in the oven.

(Baking) Bake them at a temperature of 170° C. for about 17 to 18 minutes.

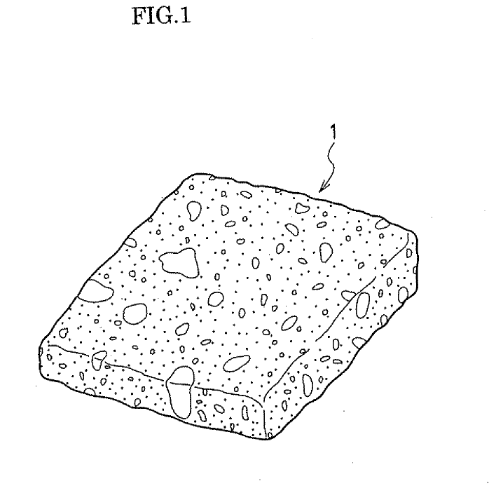

1) Bake them until the surface and the bottom of each piece are darkly browned to produce a cookie 1, which reveals on the surface grains of the mixed seed and so on as shown in FIG. 1.

2) Take them out from the oven, and put them on a grid to cool them down.

3) When they are cooled down into 20° C., put them in a bag with desiccant, and store them away from moisture.

Although the above producing method will slightly be changed in accordance with the features of each ingredient along with changes in the mixing ratio of the ingredients or the kinds of ingredients to be added, the basic producing method is one described above.

Meanwhile, the expiration period shall be forty-five days or so from the date of production. The above cookies will not spoil, but since fat will be oxidized when they are left for a long time, I set the expiration period to forty-five days or so for safety in quality. Nevertheless, in the experiment, they did not cause sentient changes such as an unpleasant smell, taste, etc. even after two and a half months had passed.

Also, a small amount of cinnamon may be added to delay oxidation. This has been recognized by the present inventor's experience, and oxidation of fat can be delayed by natural antioxidative potency of cinnamon.

### Embodiment

Next, regarding physical changes in a case where examinees actually ate the aforementioned dried sardine cookies, an example of four examinees in a first group is explained. The four examinees are the present inventor (Yumita Toru); a fifty-nine-year-old male, a fifty-three-year-old female, and two females in their twenties, and physical changes in a case where the examinees actually ate the aforementioned dried sardine cookies are described below.

They continued to eat two to three pieces of the aforementioned dried sardine cookies at breakfast and dinner daily. As a result, physical changes were as follows.

[1] After Ten Days

The changes common to all of the four examinees were as follows.

The skin got shiny and moist.

The touch of the skin got smooth.

At the same time, the face was free of darkness and got so white as to be surprised by other people.

[2] After One Month

Two females in their twenties (One of them had developed ulcerative colitis at a very early stage.)

The core of the body was made, and they did not feel tired.

Also, they got ruddy and reddish.

They hardly felt menstrual cramps any more, and analgesic drugs were not needed any more.

One of them recovered from serious chronic diarrhea.

One of them completely recovered from ulcerative colitis, which is designated as an intractable disease whose useful method of treatment has not been established in the modern medical science.

[3] Other Changes of the Present Inventor

The knee pain (hard pain) caused by aging disappeared in twenty days or so.

The body hair throughout the body that had been gradually thinned grew as much as in my young days in a short period. The head hair also increased, and the white hair did not stand out more than before.

The remain of inguinal hernia operated three years ago got better. After the operation, the pain had continued long, the remain had been swollen, and the pain had got stronger since the beginning of this year, but in about twenty days of starting eating the cookies, the pain almost disappeared, and the swelling was almost relieved. This may be because regeneration of cells was activated, and normal cells were reborn at the wound.

The skin throughout the body was free of being yellowish and became as a whitish skin as in my young days.

The body gained endurance and power enough for me to be motivated to deal with matters that I had tended to think troublesome recently.

I did not feel it so tough to do 50-minute-or-so brisk walking in the morning before going to work, which was my daily routine.

[4] Other Changes of the Fifty-three-year-old Female

The liver function was recovered. The liver function had been lowered, which might have been a side-effect of a medicine to lower blood pressure, and the symptom had not been improved although she had continued to take a medicine prescribed by a doctor. When she started eating the cookies in this state, the liver malfunction disappeared as a result of an inspection in about twenty days of starting eating. The diagnosing doctor was surprised, saying, “Why can this happen?”

The present inventor has achieved results of greatly improving or completely curing atopic dermatitis, ulcerative colitis, pollinosis, endometriosis, chronic diarrhea, etc. at an extremely high rate by new cooking methods before the cookie supplements according to the present invention. The cookie supplements according to the present invention are produced after many people practiced the new cooking methods, and I further developed ideas based on many innovative results obtained therefrom.

From the present inventor's experience, I think the cookie supplements have a strong power enough to activate and regenerate various cells throughout an entire body and have a strong immediate effect. That is, I think they give almost all of the cells in a body curative powers against various diseases developed there.

These thoughts come out from the present inventor's nearly forty-yearlong experience of engaging in food, especially the experience of engaging in food by going back and forth between Japan and foreign countries frequently, and they are proved by the above results of the examinees. I understand the cookie supplements according to the present invention can have a much larger effect easily. Further, from the above results, I think they have a strong immediate effect on atopic dermatitis, pollinosis, etc.

[Effects]

The cookies according to the present embodiment have been developed based on the experimental rules obtained by observing individual examinees to determine what kind of health consequences are revealed in accordance with the kind, quality, and quantity of the aforementioned micronutrients ingested in the bodies when people eat dishes and sweets. These examinees are ones who cooked and continued to eat dishes in accordance with recipes in “Rice and Side Dish Renaissance,” which is a published book edited by the present inventor with the aim of supplementing rich micronutrients. The book, “Rice and Side Dish Renaissance,” does not use ingredients such as olive oil, dried sardine, etc. by the method of the present embodiment but is edited based on the similar thoughts to those in the present invention with dishes that activate cells of a body.

New viewpoints of the present invention differing from “Rice and Side Dish Renaissance” are the following points.

1. It does not normally occur that butter is not added to cookies categorized in sweets but olive oil is a main fat component.

2. Similarly, it does not normally occur that fine powder of dried bonito and dried sardine is added to cookies.

3. Although it often occurs that olive oil and soybean paste are added for the taste of a dish, it does not normally occur that they are added targeting consciously promoting changes of the components of the other ingredients and improving digestion and absorption.

4. It does not normally occur that a large variety of seed kinds are added recognizing clearly that they pass life onto the next generation and contain fundamental micronutrients needed for life maintenance and growth.

5. Although a notion that Japanese products are more excellent than products made in foreign countries in terms of taste and nutrition is half-taken for granted in Japan, they are in fact products lacking micronutrients most in the world along with products made in the United States. This point can be insisted with confidence from the present inventor's past experience. There has never been an example of reconsidering the nutrition science based on such thoughts.

6. There has never been a way of thinking in which cooking methods used daily for dishes in daily meals help micronutrients in the ingredients to be digested and absorbed in a body most effectively and do not alter the components.

In a process of simply baking the cookies in the oven, the inside of the cookies is not subjected to high temperature very much, and decomposition or the like of the micronutrients does not occur very much. On the contrary, extraction of specific things by high pressure application, high-temperature sterilization, and physical or chemical processing, which are processes generally used for supplement foods, destroys micronutrients. This also lets many useful micronutrients flow out.

7. At present, a notion that NaCl damages cells is a generally accepted notion. It is generally said that, the amount of NaCl must be restricted at all times. However, there has never been an example of, in the totally opposite direction from this accepted notion, actively adding NaCl to supplements enough to make people feel considerably salty, thinking that a sufficient amount of NaCl as well as rich micronutrients are necessary to activate the cells.

The cookies proposed from the foregoing new viewpoints based on the experimental rules obtained by observing the aforementioned many examinees to determine what kind of health consequences are revealed when they eat the cookies according to the present embodiment are the present invention. That is, the foregoing is a conviction empirically obtained by the present inventor. At the same time, it is a conviction obtained by curing of diseases, which is a result obtained by observing more specific changes of the aforementioned four examinees, that is, the experimental result of completely curing or greatly improving diseases whose useful methods of treatment do not exist at present such as ulcerative colitis, atopic dermatitis, endometriosis, pollinosis, etc.

The cookies according to the present embodiment give effects on maintenance/improvement of body health and can be readily ingested by anyone. Also, they can be readily eaten as nibbles, have no negative features such as strong smell, and got an evaluation of being very delicious by eight out of ten people who ate the cookies on trial. They are dietary supplements that people can continue to eat long with happiness and enjoyment of eating easily.

### Other Embodiments

Next, other embodiments are explained based on Tables 1 and 2.

TABLE 1
[Five Different Type Mixing Ratios]

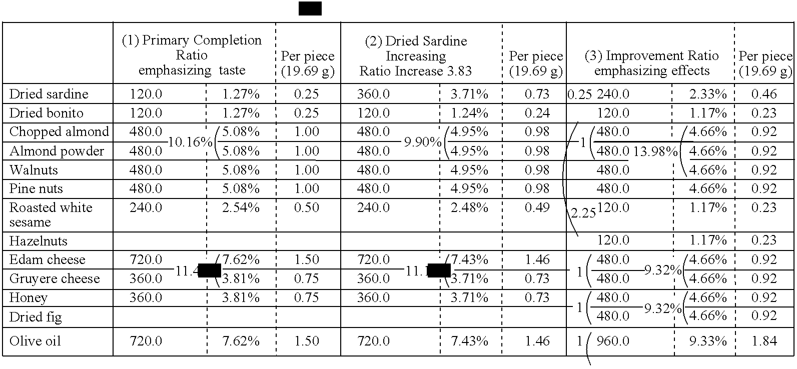

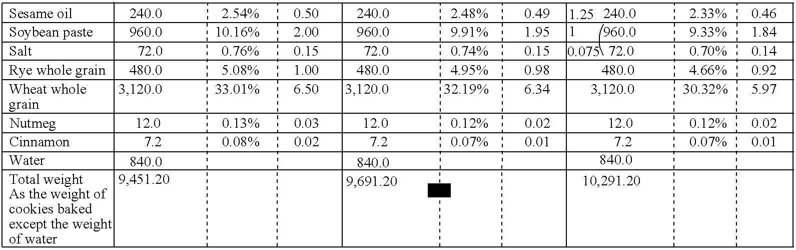

TABLE 2

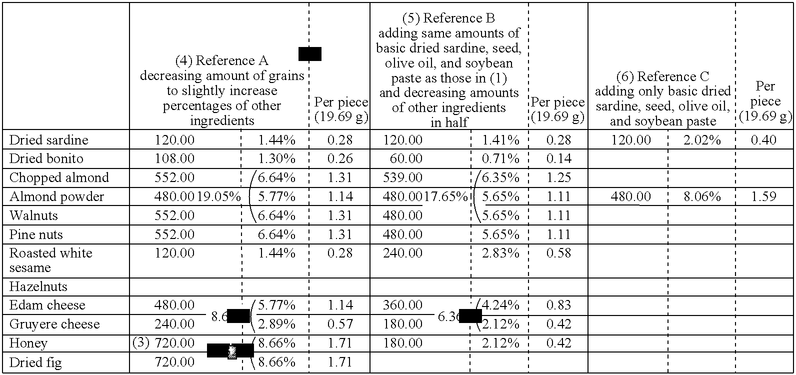

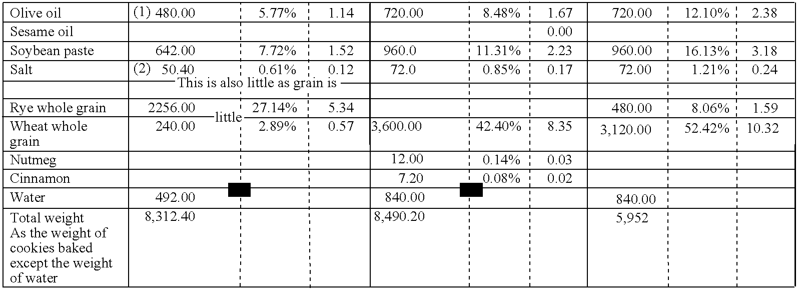

It is to be noted that each total weight of (1) to (6) in Tables 1 and 2 differs as a matter of course since the amounts of ingredients to be added are different. Here, the total weight was calculated in accordance with the actual mixing ratio at the time of the trial production, and the percentages of the respective ingredients were calculated.

In Tables 1 and 2, the weight of (1) Primary Completion Products was regarded as a standard weight. The total weight was 9,451.2 g, and 480 pieces of cookies were made from this. Thus, a piece of cookie weighs 19.69 g (9,451.2 g/480=19.69 g per piece). The 19.69 g per piece of cookie was applied to all of (1) to (6) in Tables 1 and 2.

Multiplying a percentage of each ingredient in each item in (1) to (6) by the weight of a piece of cookie (19.69 g) gives each actual weight of each ingredient in a piece of cookie. Mutual comparison was done by these values.

e.g.) Case of (2) in Table 1

Percentage of dried sardine (%)

(360/9,691.20)×100=3.71%

Weight of dried sardine per piece of cookie

(9,451.2/480 pieces/100)×3.71=0.73 g

Percentage of olive oil (%)

(720/9,691.2)×100=7.43%

Weight of olive oil per piece of cookie

(9,451.2/480 pieces/100)×7.43=1.46 g

e.g.) Case of (5) in Table 2

Total weight: 8,490.20 g
Percentage of dried sardine (%)

(120/8,490.20)×100=1.41%

Weight of dried sardine per piece of cookie

(19.69/100)×1.41=0.28 g

Percentage of olive oil (%)

(720/8,490.20)×100=8.48%

Weight of olive oil per piece of cookie

(19.69/100)×8.48=1.67 g

In Tables 1 and 2, 960 g shall be 1.

Case of (3) Improvement Ratio in Table 1

| | |
|---|---|
| Dried sardine | 0.25 |
| Almonds | 1 |
| Cheeses | 1 |
| Honey, dried fig | 1 |
| Olive oil | 1 |
| Salt | 0.075 |
| Seed including almonds | 2.25 |
| Olive oil and sesame oil | 1.25 |

Case of (4) Reference (A) in Table 2

Since the amount of olive oil to be absorbed is reduced due to a small amount of grains, the amount of olive oil to be added is small.

Since the cookies will be too salty if the same amount of salt is added due to a small amount of grains, the amount of salt is also small.

I attempted to raise the effect of honey, but since the cookies would be too sweet with this amount, the amount is reduced in (3)

Improvement Ratio. It is also reduced in half, 360 g, in (1) Primary Completion Ratio and so on.

The percentage of the ingredients except the grains in (1) Primary Completion Ratio in Table 1 is:

100−(5.08+33.01)=61.91%

since the percentage of the grains is (5.08+33.01) %.

On the other hand, the percentage of the ingredients except the grains in (4) in Table 2 is:

100−(27.14+2.78)=69.97%

since the percentage of the grains is (27.14+2.78) %.

69.97−61.91=8.06%

The amount of the micronutrient group except the grains in (4) in Table 2 is about 8% larger than that in (1) in Table 1.

Other embodiments are explained based on Tables 1 and 2.

1) Through about three-year-long communications with people who practiced the cooking methods in “Rice and Side Dish Renaissance,” the following things are indisputable facts.

When a necessary amount of the following ingredients are added to a soybean taste soup, a bowl of rice, vegetables in side dishes, and various kinds of other ingredients that are eaten daily, cells will be significantly activated, and various diseases will be significantly improved.
Dried sardine, seed (especially, almonds made in Spain), olive oil made in foreign countries (especially, one made in Spain), soybean paste, and natural salt (especially, rock salt made in Mongolia)

2) In addition to these in 1), I added cheese, honey, dried fig, dried bonito, walnuts, and pine nuts. These were added based on my past experience to broaden the variety of micronutrients that I think fundamental to life maintenance more than in the case of 1) and to make the cell activating power stronger and more certain.

As a result of multiple-time trial productions emphasizing the taste as well, the cookies with the ratio, Primary Completion Ratio, in Table 1 were completed. By doing so, the body cell activating power and the curative power were raised further significantly as targeted, and this was revealed as the further remarkable improvement in the body conditions of the monitors as described above.

[Consideration on the Variety and Quantity of Micronutrients needed to Gain the Sufficient Cell Activating Power]

1) About the aforementioned two female monitors in their twenties in the first group, the following monitoring results were obtained.

(The cookies they ate were ones in (1) Primary Completion Ratio in [Trial Table].)

The two female monitors in their twenties in the first group continued to eat three pieces of the aforementioned cookies per day and hardly felt menstrual cramps any more in their second menstruation after they started eating them.

However, when the amount of eating them was reduced to a piece per day after two months, their body conditions as well as their complexions turned poor again, and they felt menstrual cramps again although they did not feel them as much as before.

Women's menstrual conditions and cramps not only show themselves but can also be a useful barometer in determining women's entire health conditions. It is known that people suffering from diseases such as atopic dermatitis, pollinosis, ulcerative colitis, etc. feel strong menstrual cramps or have menstrual disorder highly probably.

People in good health condition supplied with sufficient micronutrients to the cells throughout their bodies feel no cramps or almost no cramps in many cases.

Right now, both the two females eat two pieces of the aforementioned cookies per day. Under such conditions, one of them, who recently eats dishes in “Rice and Side Dish Renaissance” at home every day, has as a good complexion and a good body condition as when she ate three cookies per day.

However, the other female, who does not eat daily meals as properly as the above female, is also fine and keeps a slightly less good complexion than when she ate three cookies per day. There are other such examples.

As was expected, it seems that people who eat meals in “Rice and Side Dish Renaissance” as well as the cookies obtain effects quickly and significantly. That is, in the first female's case, various kinds of different ingredients such as vegetables included in the meals, other than the cookies, seem to give her cells a wide variety of micronutrients and better health.

Nevertheless, both the first and second females did not have meals in “Rice and Side Dish Renaissance” yet at that time but became in much better condition than ever before by continuing to eat three cookies per day, which seems to be caused by the cookies. This shows that ingesting the cookies will activate the cells as significantly as ingesting the meals if a smaller variety of ingredients contained in the cookies than those contained in daily meals made from more ingredients such as vegetables are a mass of fundamental micronutrients that are more related to life such as seed.

In regard to this, there is a following example. It is an example of a female in her early thirties. She continued to eat two to three meals in “Rice and Side Dish Renaissance” per day almost constantly for three years and became considerably in better condition than ever before. However, further effects of the aforementioned cookies were revealed clearly. She continued to eat two cookies per day. Her skin that had already been smooth became much smooth. After twelve days, the cycle of her menstruation that had tended to be delayed slightly became just right, and she did not feel sleepy before and after the menstruation and did not feel cramps at all enough to forget she was in her menstruation. After three weeks, her skin got more white and smooth. Her hands did not get rough and dry although she laid her hands on water in her daily work.

2) Thus, a conclusion can be obtained from 1) that ingesting a larger variety of and a larger amount of micronutrients is good for activation of cells.

In terms of the larger variety, it seems to be important to ingest every possible ingredient in the ingredient group in 1) and 2) supported by the aforementioned various thoughts and grounds.

Next, in terms of the larger amount, it seems to be all that is needed to simply increase the number of cookies to be eaten until clear effects are revealed.

For example, when the amount of the micronutrients contained in two cookies is too insufficient to obtain effects, adding one to two more cookies can reach the sufficient amount easily, and effects can be obtained.

As described later, according to the past monitoring results, definitely 100% monitors obtained remarkably positive changes when they ate three to four cookies per day, and thus one should decide the amount to be ingested per day in accordance with this rough standard and continue for about fifteen days.

He/she should keep the number when he/she obtains positive results, while he/she should add one to two more cookies when he/she obtains only small results, and he/she should see how it works for a half month, checking changes in his/her symptom well.

Also, what is noted is a point in which it seems he/she does not have to be worried at all even if a larger amount of several kinds of micronutrients than necessary to the body is ingested in the body as a result of increasing the number of cookies to be eaten. Unlike carbohydrate and fat, it seems they will not be accumulated in the body as fat but will be excreted to the outside of the body regularly and will never damage the body.

Here, what is recognized again is the fact that the mixing ratio of the ingredients herein was determined by mixing the ingredients that the present inventor thought effective from my experience in just proportion based on my experience and through multiple-time trial productions and, above all, the fact that this brought about more rapid and significant cell activation than ever before in the bodies of many people who ate the cookies undoubtedly as truth and contributed to miraculous improvement of various diseases that cannot be cured by the modern medical science such as diseases designated as intractable diseases.

I understand this can be derived by the following thoughts.

The most basic thought in this supplement is broadening the variety of and increasing the quantity of more fundamental micronutrients as much as possible, activating all of the cells in a body simultaneously, making positive changes in mutual effects among the cells, and improving the tissues and organs at an ill part at the same time of improving the whole. A partial coping strategy is not intended at all. The ingredients used herein are very important and fundamental to life maintenance and should be supplied to all of the cells sufficiently in the present inventor's view. It is a thought that there is no need to think to which cells each ingredient used herein is well effective, and that increasing the amount of the ingredients indicated, that is, preparing equivalent amount of every ingredient except salt in principle, and supplying the micronutrients to all of the cells sufficiently to activate the cells will lead to health. If the difference in quantity and ratio of each ingredient is made, one with small amount and ratio may not be supplied to all of the cells sufficiently, and thus the ratio so as for every ingredient to be supplied to all of the cells sufficiently should be adopted. To do so, the ratios in Tables 1 and 2 were proposed.

Based on this thought, an after-mentioned Improvement Ratio in Table 1 ((3) Improvement ratio in Table 1) was born, which seems to bring about most certain, most rapid, and most apparent effects.

In other words than the aforementioned, making the cookies by combining the aforementioned ingredients seems to be more important than changing the ratio among the ingredients used several times and strictly examining which ratio brings about the most favorable effects. Too much complicated mutual reactions among enormous kinds of micronutrients contained in the ingredients are beyond the extent of current human knowledge and are not easy to clarify even if people intend to know them. When the ratio and the quantity are changed, the optimal quantity to individuals will be found, and thus it is more preferable to specify the ratio among the ingredients and the quantity (number) of pieces in accordance with individuals' respective conditions than examining the absolute ratio and quantity. That is, based on the five basic ingredients; whole fish (dried sardine), seed, natural salt, olive oil, and soybean paste, other ingredients are added as needed to bake the cookies in conformity to individuals.

The present monitoring results of the cookies in Primary Completion Ratio in Table 1 are as follows.

(1) Normal adults with average physical size (three to four pieces or more)

(2) Adults with larger physical size (four to five pieces or more)

The present inventor (177 centimeters tall and weighing 74 kilograms) eats four pieces per day. The reason for limiting the number to four pieces is that I am at the stage of trial production yet now, and the number of pieces to be produced is limited. However, I feel even this number has given me enough cell activating power to alter my life philosophy totally and to rejuvenate everything in me. Meanwhile, in my own feeing, eating five to six pieces may bring about further better results.

(3) People with chronic or acute diseases: four to five pieces (A female with average physical size with ulcerative colitis: Her symptom was rapidly improved with four pieces per day.)

(4) People who cannot have daily meals sufficiently, people who mostly eat meals of each day out, and people who tend to finish with their meals by ready-made foods and lunch boxes, sweet buns, or instant noodles: four to five pieces

(5) For people in the aforementioned (2) who are in normal states requiring no urgent measures, Primary Completion Products in Table 1 will be sufficient, which are delicious and have remarkable effects.

(6) For people in the aforementioned (4), Improvement Products in Table 1 will be proper, which include twice as much dried sardine as Primary Completion Products and include other ingredients to a maximum extent.

[Way of Thinking of the Mixing Ratio of the Ingredients in Improvement Products of the Supplement Cookies Most Emphasizing Cell Activation (refer to (3) Improvement Ratio in Table 1)]

It seems that the kinds of micronutrients required by many various cells constituting a body differ with the cells, and that the variety is extremely wide. The size and weight of a cookie are limited, and in order to avoid excess and deficiency in quantity under such conditions, basically, the amounts of the respective ingredients should be added to the maximum, that is, equivalent amount of every ingredient should be mixed, without thinking which one is less and which one is more.

Based on this basic thought, the amounts of several ingredients were further increased or decreased from the present inventor's experience.

As for (1) Primary Completion Products, being delicious was emphasized. I think the balance of the respective ingredients is excellent, and everyone says these are the most delicious. Also, since they even brought about remarkable effects, this mixing ratio seems to be enough if no urgent solution is specially needed.

(Natural Salt)

Salt Plays an Important Role of a Catalyst to Make a Chemical reaction among the micronutrients smooth.

In this mixing ratio, salt contained in soybean paste and cheese to be added is included as well as natural salt. The amount of salt per four cookies for a day is about 2 g. With this amount, the cookies taste sufficiently salty and delicious, and thus this shall be the upper limit. It is meaningless to add so much salt as to taste too salty to eat.

On the other hand, since the required amount of salt differs as a matter of course with the physical size, it shall be adjusted by the number of cookies. When one cannot ingest a sufficient amount of salt at the time of a business trip or due to other family member's preference, he/she can get a sufficient amount of salt by increasing the number of cookies.

When the amount of salt to be ingested is reduced by 10 to 20%, there will not be so big differences in effects, but when it is reduced to ⅓ or less, the cell activating power will be lowered.

However, for people who refrain from taking salt as much as possible in accordance with the accepted notion in the present nutrition science and medical science, some kind of effects will definitely be obtained despite a slow pace even if they take only ⅓ of salt.

(Honey)

When honey was added at an equal ratio to each of the other ingredients in the trial mixing ratio in (4) Reference A in Table 2, the cookies themselves were too sweet and were rejected in terms of the taste by everyone that ate them, and thus the amount was reduced to ½.

(Seed)

I thought seed was especially important and made the ratio of the entire amount of seed twice as much as the ratio of the amount of each of the other ingredients. Five kinds of seed containing fundamental micronutrients that pass life onto the next generation were added to further broaden the variety.

As far as the present inventor knows, many people who like seed such as peanuts, boiled soybeans, soybeans, etc. are very healthy and lively. Also, I often hear a story in which ingesting almonds made in Spain makes a skin beautiful and cures cracked heels. Also, a simmered dish or a soybean paste soup in which seed is put is really delicious, and I feel powerful on the day after I eat this. The present inventor has thought seed is one of the important soup bases in the cooking and has practiced it. The present inventor is often said even now to have a young and beautiful face skin that cannot be seen in other coeval males, and I think this is because of the aforementioned practice. Although the present inventor is sixty years old, I am said to have a skin of a person in his twenties or thirties.

The ratio of seed was doubled based on my actual feeling, coming from my own experience, that seed is very delicious and abundantly contains micronutrients required by a body. Also, to broaden the variety of micronutrients, I further added Hazelnuts made in Spain.

(Dried Sardine, Dried Bonito)

(1) In Primary Completion Ratio, 0.25 g of dried sardine is included in one cookie, and 0.75 is included in three cookies.

With this amount of dried sardine, various remarkable effects were obtained. However, this amount of dried sardine is premised on having “meals” at breakfast and dinner every day. The amount of dried sardine to be ingested from a soybean paste soup, a bowl of rice, etc. to which dried sardine is added in accordance with recipes in “Rice and Side Dish Renaissance” is about 2 to 3 g per person per day although it differs with the amount of meals each person eats. With this amount, a large number of people have been recovered from atopic dermatitis. I think this amount is sufficient since one included in the cookies is added to one in the meals.

Also, if dried sardine is added any more, fishy smell of dried sardine will get strong, and easy-to-eat good taste to be eaten naturally and continuously will be lost.

(2) However, on a trial basis, the amount of only dried sardine among the ingredients in Primary Completion Ratio was made to be three times (360 g) to make the cookies including 0.73 g of dried sardine per piece and 2.19 g per three pieces (refer to (2) Dried Sardine Increasing Ratio in Table 1). The aforementioned two females in their twenties were monitored.

Although they had eaten two cookies in Primary Completion Ratio (0.5 g of dried sardine per two cookies), they started eating a piece of this cookie whose dried sardine was increased, and I saw how it would work. Although the number of cookies was reduced to one, the amount of dried sardine was eventually increased 1.46 times and was 0.73 g per piece. Although everything except dried sardine was reduced in half, as positive changes, the menstrual cramps of the two females were eased further, and the bowel movement of one of them was improved. However, as negative changes, both of them could not get up early in the morning any more and felt sleepy all day long. Also, one of them began to have a cold constitution.

The sleepy feeling and the cold constitution seem to have occurred because ingredients except dried sardine were reduced in half, and the cells were inactivated. However, the fact that the increased dried sardine brought about positive changes such as easing of menstrual cramps even under such conditions means that dried sardine gives great effects on the reproductive system, and that more dried sardine than that in Primary Completion Ratio is better.

In view of the result in the aforementioned (2), the effect was slightly more emphasized than the taste, and in Completion Products ((3) Improvement Ratio in Table 1), the amount of dried sardine was doubled (240 g), which was 0.46 g per cookie and 1.38 g per three cookies. This showed increasing the amount of dried sardine would bring about a positive result to some part of a body in some cases even with only a piece. Moreover, as a conclusion, the more the amount of dried sardine is up to a considerable amount, the better the result becomes on condition that the taste is adjusted, and this is verified by further monitoring.

(Cheeses, Soybean Paste, Dried Fig)

As for the ratio of each of these three kinds of ingredients to another ingredient, 1 seems to be sufficient.

(Olive Oil, Sesame Oil)

In Primary Completion Products, the sum of sesame oil and olive oil used together to broaden the variety of micronutrients in oils was used to calculate its ratio to another ingredient. However, olive oil is extremely important since it not only contains rich micronutrients in itself but also has a power to resolve other ingredients so as to be absorbed easily. From the following reasons, the ratio of oils to another ingredient was calculated only in consideration of olive oil, and the amount of olive oil was increased.

The power of olive oil is enormous enough to surprise me because I ate bread with about 10 g of olive oil every day, and my skin was kept smooth even when I suffered from influenza.

In the recipes in “Rice and Side Dish Renaissance,” 20 to 30 g of olive oil per family consisting of three people, that is, 7 to 10 g per person, was ingested from a bowl of rice, a simmered dish, etc. per day, and their physical conditions were remarkably improved.

Also, in Spain, where people ingest a large amount of olive oil daily, there are very few obese people, and their skins are beautiful and energetic. I also hear an area where people ingest a large amount of olive oil has many people who live long.

Olive producers in Spain who make deals with the present inventor put olive oil to any food when they eat it. They ingest 20 to 30 g of olive oil per person. When the present inventor goes to Spain, I also ingest as much olive oil. However, I never feel heavy stomach feeling. At the end of a meal, I feel so fine in my stomach that I feel as if I wanted to begin the meal again. The digestion of olive oil really surprises me. Also, in Spain, since the present inventor also continued to eat olive oil together with an ingredient group with rich micronutrients, my body gained power, and I felt about five-hour sleep was sufficient.

In Primary Completion Products, the amount was 1.5 g per cookie and 6 g per four cookies, by which a sufficient result was obtained. I increased the amount up to the same amount as that of each major ingredient such as seed, cheeses, etc. so that micronutrients in olive oil would be delivered to all of the cells throughout a body reliably, and the amount was 1.84 g per piece and 7.36 g per four pieces.

(Basic thoughts that Led to Improvement Mixing Ratio most Emphasizing Evocation of the Cell Activating Power)

Although even Primary Completion Ratio brought about various surprising effects, (3) Improvement Mixing Ratio of the indicated ingredients was figured out as one from which the maximum effects for activation of all of the cells in a body can be expected as described above. Improvement Completion Ratio was figured out so as to bring about larger effects to all of the cells further reliably. This also showed a stronger immediate effect than expected as described later.

The most important thing is the amount to be ingested actually. What influences the extent and rapidity of cell activation and other effects is eventually not the ratio among the ingredients but the amount to be ingested actually. The ratio among the ingredients has been specified so that the required amount of every ingredient can be ingested efficiently.

Even if the cookies are ones whose ratio among the ingredients has been changed as one thinks is proper, their ratio will be closer to Primary Completion Ratio or Improvement Completion Ratio, and the effects will be greater when the amount to be eaten is increased, that is, the number of cookies is increased from one to two. As a matter of course, the amounts of some ingredients may exceed the amounts indicated herein, but the amounts of all of the ingredients will be close to the amounts preferred herein as the number of pieces is increased. If the amounts of all of the ingredients except grains and water in Improvement Products are increased, the amount of micronutrients will be increased in the case of eating three cookies regardless of the ratio among the respective ingredients, and thus the effects by three or more cookies are obtained reliably. If the amount of everything except grains and water is decreased in half, the amount of micronutrients will lack significantly, and thus the effects will be decreased in half in the case of eating the same number of cookies. However, if six pieces of the cookies with the halved mixing ratio, which is derived by multiplying the normal number, three pieces, by two, are eaten, the totally equal result can be obtained reliably. The number can be adjusted in accordance with the amount of food that a person who will ingest the cookies eats normally. Also, ingesting too much amount sometimes makes the ingesting person feel a little tough or is not preferable with respect to the amount of calories to be ingested.

Although halving the amount of the ingredients in Improvement Products will halve the effects, a small decrease such as a 10% to 20% decrease will not cause differences in effects so much. This is because, similar to the way even Primary Completion Products, in which some ingredients are slightly less than those in Improvement Products, brought about large effects, the cookies with such a small decrease will bring about some kind of large effects close to the effects by three pieces of Improvement Products even if the number of cookies to be eaten is not increased from three to four.

There is an example to support this paradoxically. This is a case of the aforementioned female in her late twenties, who had had severe cramps and nausea in her menstruation, whose symptoms were remarkably improved by three cookies in Primary Completion Ratio, and who got reddish in her face.

She started eating three pieces, which is the same number as before, of cookies that have a less amount of grains and relatively have a more amount of micronutrients per piece in the ratio in (4) Reference A in Table 2. When the amounts of ingredients included in a cookie in (1) Primary Completion Ratio and in a cookie in (4) Reference A are compared, the amount of the ingredients in the cookie in (4) Reference A is about 8% more as shown below.

100%−(grains 5.08+33.01)=61.91% (1)

100%−(grains 2.89+27.14)=69.97% (4)

69.97−61.91=8.06% more

However, such a small increase did not give a new remarkable effect at least in the short term on the cells that had already been activated sufficiently by (1) Primary Completion Products.

Accordingly, it seems that monitoring is not needed about cookies made by decreasing the amount of the ingredients in (1) Primary Completion Ratio by a small degree (10 to 20%) and cookies made by increasing it since the results are already apparent.

[Mixing Ratios to be Confirmed and Monitoring by a Third Group]

I need to examine how the following cases work: a case of adding a predetermined amount of each of the fundamental ingredients such as dried sardine, natural salt, almonds, soybean paste, olive oil, etc. from the aforementioned ingredient group and drastically decreasing the amounts of other ingredients to 30 to 50% or adding other new ingredients, and a case of excluding ingredients other than the fundamental ingredients completely. The examples of these examinations are (5) Reference B and (6) Reference C in Table 2.

(5) Reference B is one in which dried sardine, seed, olive oil, soybean paste, and salt as the fundamental ingredients are not changed and are the same as those in Primary Completion Ratio, and in which the amount of the other ingredients was reduced in half. (6) Reference C is one in which only the five fundamental ingredients are mixed in the grains.

A female monitor of (5) Reference B is in her late twenties, and she has practiced “Rice and Side Dish Renaissance” over the past year and seems to be in good physical condition recently.

On the morning of the day after three days of starting eating them, she noticed that the usual swollen face at the time of getting up in the morning disappeared. After a half month, her face got whitish little by little.

A monitor of (6) Reference C is a female in her late twenties who does not eat “Rice and Side Dish Renaissance” and is rather tired recently. In about a half month of starting eating them, her face got whitish little by little, and pollinosis was mild although the symptom had been very serious every year.

From these results, I can predict that even the products whose ratio is changed as one thinks is proper or which excludes several ingredients can bring about an approximately 50% result even now as long as the products comply with thoughts and cooking methods of selecting this ingredient group although they may not attain a 100% result that can be obtained by Primary Completion Ratio or Improvement Completion Ratio.

However, even a 50% result will be a much bigger result than before for a person who took very few micronutrients clue to unfavorable daily meals and was in a state of an extremely low cell activity and will cause significant improvement of his/her physical conditions and diseases.

The [ingredient group] selected based on such thoughts has not existed before. Also, there is the fact that this contributes to miraculous improvement of various diseases that are said to be incurable in the present medical science for a short period at an extremely high rate.

[Monitoring Result of a Second Group]

The following is a result in (1) Primary Completion Ratio in Table 1.

[A Female in her Late Thirties with Basedow's Disease, three Cookies Per Day]

In ten days of starting eating the cookies, her strong and painful stiff shoulders which she could do nothing about disappeared, and she felt her body light. Also, the back of her hand got very white.

She underwent a test of Basedow's disease in a half month of starting eating, the symptom was considerably improved, and she was told not to need medicines.

Her symptom had already been improved considerably when she started eating the cookies. However, a recovery only by the medicines does not lead to a real recovery, and the symptom is swung back in many cases. However, if micronutrients are continuously supplied via the blood vessels, the symptom will be improved more quickly, and the improved state after the recovery will be stable. I look forward to the future test result.

Also, the reason why she wished to be a monitor of the cookies is that she experienced miscarriage in the past, now reached an advanced age of forty years old, and wanted to somehow strengthen her body to give birth to a child at any cost. Then, in her case, I heard a new of her pregnancy in three months of starting eating the cookies. When this is considered as well as the after-mentioned pet dog's pregnancy and delivery, it can be understood that there is no such big difference in body structures between a human being and a dog.

[A Female in Her Late Twenties with Atopic Dermatitis, Three Cookies Per Day]

She had always been suffering from atopic dermatitis. She started eating meals in “Rice and Side Dish Renaissance” about one year and a half ago. However, although she should have had this twice a day at breakfast and dinner actually, she had it only once at breakfast, the improvement of the symptom was halfway, and she made almost no progress for some time.

In one month of starting eating the cookies, the symptom was improved enough to be told by other people her skin became beautiful. Also, the inflammations at the knees and elbows, which have not disappeared in any manner, are almost cured.

[A Female in Her Mid Thirties Suffering from Ulcerative Colitis for Years]

She started eating meals in “Rice and Side Dish Renaissance” and continued to eat three cookies per day.

After a month, she was free of bleeding, which had occurred almost inevitably when she was busy at the end of the year, and the amount of medicines was reduced to one tablet. She gradually gained weight and had a good complexion.

After a while, the present inventor met her and found her past skinny pale face disappeared completely. Her face got plump, and her complexion was changed to a healthier and more beautiful pink color than other normal people's. I thought the disease would be completely cured soon.

[Monitoring Result by Improvement Ratio]

Among three examinees, a first group has two people consisting of the present inventor; Yumita Toru, and a fifty-three-year-old female, and a second group has one person consisting of a twenty-eight-year-old male.

As for the first group, in about a half month of starting eating the cookies, their faces got more whitish, moist, and shiny.

Above all, they came to quick and brisk body movement and strongly felt recovery of power.

The male in the second group had suffered from considerably severe atopic dermatitis. Surprisingly, in about twelve days of starting eating the cookies, his sore face almost disappeared. Everyone did nothing but being surprised.

Also, he started eating the rice and the soybean paste soup in “Rice and Side Dish Renaissance” at the same time of starting eating the cookies.

[Other Monitors]

A nurse in her thirties with no special health problems who hardly practices “Rice and Side Dish Renaissance”

She works in three shifts including a night shift. In about one week of starting eating the cookies, she had a good bowel condition, and the bowel movement was improved. Before that, she had felt significantly slack especially at the beginning of a shift from the evening, and it had taken a long time before she felt motivated to work, but this was eased. After about two months, she did not feel so tired after work.

She said the fact that her average body temperature was raised from thirty fives to low thirty sixs might be caused by the cookies. Also, she had had a very poor and dark complexion due to chronic fatigue from night shifts. After two months, her face was free of darkness and got really so white, shiny, and moist as to be surprised by me and people around her.

Although the number of monitors is small as above, both those in good physical condition and those in poor physical condition among them achieved improvement of their physical conditions in a short period to the extent that they could be aware of it. Improvement occurred in all of the monitors. Moreover, a disease at a different part of the body of each monitor was improved or completely cured. I think this is one of the proofs that the cookies supply all of the cells in a body with sufficient micronutrients and activate all of the cells as described above.

Also, the fact that her average body temperature was raised from thirty fives to low thirty sixs was confirmed by the monitor who is a licensed nurse, which I think meaningful. This seems to be exactly because the micronutrients in the cookies activated all of the cells throughout the body significantly.

[Application Examples of the Cookies]

Possible applications of the aforementioned cookies are as follows.

1. Supplement of micronutrients to people with irregular dietary lives

For example, the cookies can be used as food to supplement micronutrients to students or transferred husbands who live away from parents or their families and tend to pay no attention to meals.

2. Supplement of nutrition after operation

Since the cookies have a function to activate cells of a body, they can be used as food to supplement micronutrients for scarless recovery and quick recovery.

3. The cookies can be used as food to supplement micronutrients to people whose cells need to be activated urgently, such as those with ulcerative colitis, endometriosis, etc.

4. The cookies can be used as dietary supplements to supplement micronutrients for improvement of symptoms of people with severe atopic dermatitis or pollinosis by supporting powerful energy of the cells of the bodies.

5. The cookies can be used to support hospital meals extremely lacking in micronutrients in which micronutrients are not taken into consideration at all.

6. The cookies can be used as supplements for recovery of people suffering from serious fatigue.

7. The cookies can be used to restrain functional decline and weakening at various parts of a body caused by weakening of the cells due to aging and keep his/her youth.

8. The cookies can be used to make a face and body skin moist and smooth. They can also be used to obtain a whitened skin by removing flecks and dullness from the face.

9. As for a hair growth tonic and an energy-reinforcing agent, using only this cannot bring about something like an effect in many cases. However, when the cookies are ingested continuously, cells will be activated, and a remarkable effect on hair growth, energy recovery, etc. can be obtained, which I know from my own experience.

10. Since the cookies according to the present invention activate cells of a body, I understand they can exert almighty effects on various diseases at various parts of the body.

### INDUSTRIAL APPLICABILITY

Although the baked cookies shall be eaten as they are in the foregoing embodiments, they may be used as an ingredient of other sweets. In this case as well, the similar effects to those in the foregoing embodiments can be obtained.

Although dried sardine was finely ground and mixed in the cookies in the foregoing embodiments, dried sardine may be used as it is in a case where it consists of small fish. When one wants to enjoy the texture of dried sardine itself, it will be used without being ground.

The mixing ratios among the respective ingredients described in the foregoing embodiments are not fixed as described above and will be changed depending on ingredients to be added or application. Specifically, whole fish (dried sardine, etc.), seed, natural salt, olive oil, and soybean paste are basic, and other ingredients may be mixed in accordance with a person to eat them. By deciding the mixing ratio in accordance with a person to eat them, one can ingest micronutrients more effectively.

Although the solid cookies and the powdered flakes have been exemplified as dietary supplements in the foregoing embodiments, they may be made in a paste state. For example, all of the ingredients may be mixed and made in a paste state. In this case, it may be used with other ingredients in the cooking, may be spread on a sliced bread instead of butter, may be put on a bowl of rice like layer boiled down in soy and eaten, or may be used in various manners.

The five basic ingredients, that is, whole fish (dried sardine), seed, natural salt, olive oil, and soybean paste, can bring about an effect close to an original effect down to a 30% decrease in the amount. For a person who continued to have meals significantly lacking in micronutrients and got in poor physical condition, remarkable improvement in his/her physical condition may be seen even with the ⅓ amount.

The processes from mixing of the ingredients to baking in the foregoing embodiments may be done manually or fully automatically by mechanization.

[Usage Example as a Micronutrient Supplement for Cell Activation Other than in a Cookie Form]

Among the mixed ingredients of the cookies, grains and water are intended to form various ingredients that are the sources of micronutrients in cookie shapes with natural good taste and enable anyone to ingest them continuously without being tired of them. These are added with a view to create good taste by alleviating the taste of dried sardine with a strong smell and alleviating a surprise at and a feeling of strangeness to the taste generated from the combination of the ingredients that no one experiences and that is incomprehensible under normal circumstances by covering the taste with the starch of the flour. Also, since extraction of components from ingredients is not done at all, and the ingredients themselves will be ingested as a whole, in order to ingest the necessary amount of micronutrients corresponding to those in three cookies, about 45 g of micronutrients, which is a large amount, must be ingested in a state where grains are not added. This is considerably difficult. Accordingly, adding grains, forming the ingredients in cookie shapes, and giving them good taste have enabled one to eat a large amount of micronutrients every day.

However, if the taste is not given first priority, decreasing or eliminating the amount of a wheat whole grain from the mixture, simultaneously decreasing the amount of water in proportion to this, and using it in shapes other than the cookie shapes will bring about the same effect. This is because the wheat whole grain surely contains rich micronutrients, but does not seem to have micronutrients that are closely related to life since the starch almost occupies its weight, and does not need to be put in such large quantity, and making its amount about ¼ of the entire amount of the cookies seems to be sufficient. When the amount of flour is decreased, the ingredients are finished in a granular form without forming in plate shapes as cookies, and a necessary amount of the granulated powder is ingested, the same effect can be obtained as a micronutrient supplement for cell activation. Also, in the mixing ratio in this case, the amount of grains is too small to absorb the amount of olive oil in (1) Primary Completion Ratio, and thus the amount of olive oil shall be decreased.

“Method for producing the dietary supplement in a flake form so as to be used as flakes for a bowl of rice, a wheat noodle, or a soybean paste soup, as a soup base or flakes for a simmered dish, or as things to be mixed into a rice ball”

(1) Grind walnuts by a food processor to 3 to 5 mm grinds at the maximum.

Also, finely grind dried sardine and dried bonito by a food processor in a similar manner.

(2) Dissolve soybean paste and honey in water.

(3) Put (1), all seed, cheeses, salt, grains, and spices in a large bowl, and mix them well.

(4) Put oils in (3) in three batches, mixing and crumbling them well in each batch.

The entirety is getting moist gradually.

(5) Next, put (2) in three batches, mixing and crumbling them well in each batch. A ball is gradually made. Eventually, a 2 to 3 cm big ball is made.

(6) Spread it on a sheet pan for the oven, and put it in the oven at a temperature of 170° C.

(7) When the surface is browned, take it out from the oven, crumble the ball into pieces by two spatulas, and mix them well.

(8) Put them in the oven again, and when the surfaces are browned, take them out from the oven, do the same process as (7), and put them in the oven (about twenty minutes at a temperature of about 170° C.).

(9) Repeat this until the entirety is browned, and dry them well until crisp.

Meanwhile, the biggest dough ball shall be 1 cm.

(10) When they are well browned and dried, cool them down.

Meanwhile, if they are baked too much until they are blackened, the taste will be spoiled, and the vitamins will be altered poorly, and thus bake them until mild brown.

(11) When they are cooled down, put them in packs or the like.

For example, in a pack, 45 g of the flakes corresponding to three cookies per person per day is put. One has only to ingest it in a day by sprinkling it on various dishes.

[How to Eat the Flake-formed Micronutrient Supplement]

As flakes or for a bowl of rice with green tea, sprinkle one pack, 45 g, on one or two bowls of rice.

As flakes, eat this as it is. For a bowl of rice with green tea, since the rice and flakes only with green tea do not have enough salt, add salt or soybean paste if desired, and eat it. Also, by adding green layer, one can make green-layer-flavored flakes.

For a bowl of soybean paste soup, put about a ⅓ pack on the soybean paste soup filled in a bowl, and mix and eat it.

Also, for a wheat noodle in a hot soup or a buckwheat noodle in a hot soup, put about a half pack in it, and eat it, and the taste of the noodle will be flavored richly and will be good.

Add 15 g of the flakes to each of the three rice balls, and one can ingest the necessary amount.

For a simmered dish, put the appropriate amount to it, and eat it. Alternatively, add it to the water as a soup base at first, add ingredients such as vegetables to it, and simmer it, and the rich taste will be obtained.

Making the supplement in a flake form enables people to ingest the 45 g flake-formed micronutrients supplement, which is a considerable amount of micronutrients corresponding to those in the three cookies, every day as comfortably and delectably as in a cookie form.

[The supplement can be given to a dog, cat, or the like as its pet food in a cookie form or by mixing the aforementioned flake-formed supplement in its food.]

Although most people will be surprised to hear a supplement that is good for human bodies is also good for animals, the present inventor thinks the kind of and the ratio among micronutrients constituting the cells and tissues do not differ between human beings and animals very much. Human beings, dogs and cats, and other animals originate from life generated in the sea, were fish for a period, became mammals via amphibians, and were branched at a certain point. Thus, their fundamental micronutrients do not seem to differ from one another very much. This is proved by the present inventor's experience.

Two male and female Labrador dogs which had been given pet food continuously suffered from chronic dermatitis (this seems to be equivalent to human atopic dermatitis) and cystitis. The symptoms became serious, and they were taken to an animal doctor and took medicines. However, they repeated getting a little better, stopping the medicines, suffering a relapse immediately, and taking the medicines again.

When “Rice and Side Dish Renaissance” was published in a timely manner, the pet owner heard the reputation that the dishes in this book were good for various diseases, did not give the medicines to the dogs any more, and began to cook dishes with use of a soup made mainly by dried sardine and give them to the dogs.

After one month, the two dogs were recovered from the diseases. Although the male dog was ten years old, which corresponds to eighty years old in a human being's case, and was very old, it became energetic enough to make the female dog become pregnant and give a birth to a child last year. Also, they once behaved themselves well, but now, when the owner begins to cook dishes, they pick up on the scent, do not obey the owner's order of sitting down, and are hopping impatiently until the dishes are done. This proves that they detect from the scent the dishes' containing significantly rich micronutrients required by their bodies. I understand both dogs and human beings want and enjoy the taste of micronutrients required by their bodies in a similar manner. I understand this phenomenon may be regarded as a kind of biological reaction.

I have heard two other stories similar to this. Also, I have heard a story that a person was surprised to see his/her pet cat snitching a dish made in accordance with “Rice and Side Dish Renaissance” that was put on a table in his/her house. According to the person, the cat had never snitched food before, and thus he/she was surprised. According to the person, he/she did not feel angry, thinking that both human beings and animals want to eat delicious food in a similar manner.

On television or the like, we see a commercial that gives us the impression that pet food contains most of the nutrients required by the bodies of dogs and cats and that the dogs and cats will be healthy immediately after they eat it, but this is totally wrong. Such pet food undergoes various processes to extend the expiration period, and vitamins are significantly destroyed. If a large amount of only such pet food is given to a pet continuously, the pet will get in poor physical condition. Although pet food contains nutrients required by dogs and cats, there are other nutrients that the pet food cannot cover, and something that supplements them and rescues dogs and cats from the poor physical conditions is cooking methods in “Rice and Side Dish Renaissance.”

From the cookies, the same effects as those from the dishes in the book can be expected, and only giving the cookies to dogs and cats instead of pet food can maintain their health.

1. A dietary supplement comprising: at least whole fish; seed; natural salt; olive oil; and soybean paste, to be produced in a powder form, in a paste form, or as a solid.

2. The dietary supplement according to claim 1, further comprising: either a wheat whole grain or a rye whole grain or both.

3. The dietary supplement according to claim 2, wherein about 30 to 60 wt. % said either a wheat whole grain or a rye whole grain or both, about 1 to 2 wt. % said whole fish, about 8 to 28 wt. % said seed, about 0.6 to 1.2 wt. % said natural salt, about 5 to 12 wt. % said olive oil, and about 7 to 16 wt. % said soybean paste are mixed.

4. The dietary supplement according to claim 1, wherein said seed includes almond powder, pine nuts, walnuts, chopped almonds, and white sesame.

5. The dietary supplement according to claim 1, further comprising: cheese.

6. The dietary supplement according to claim 5, wherein said cheese includes at least about 6 to 12 wt. % Edam cheese and Gruyere cheese.

7. The dietary supplement according to claim 1, further comprising: about 0.07 wt. % cinnamon and about 0.13 wt. % nutmeg.

8. The dietary supplement according to claim 1, further comprising: about 2 to 18 wt. % honey or dried fig and honey.

9. The dietary supplement according to claim 1, further comprising: either cordyceps sinensis or reindeer horn or both.

10. The dietary supplement according to claim 1, wherein cookies are baked with use of said respective ingredients.

11. The dietary supplement according to claim 1, wherein pet food is baked with use of said respective ingredients.

12. A method for producing a dietary supplement, comprising the steps of
1) dissolving natural salt and soybean paste in water and olive oil and mixing them;
2) finely grinding whole fish by a food processor;
3) putting all rye whole grain in a bowl, putting all ingredients except said ingredients in said step 1 in said bowl, and mixing them well;
4) scattering ⅕ of the whole amount of said water, said olive oil, said natural salt, and said soybean paste mixed in said step 1 on said ingredients in said bowl mixed in said step 3 evenly;
5) mixing powder having absorbed said water and said olive oil in which said natural salt and said soybean paste are dissolved while crumbling it;
6) scattering ⅕ of the whole amount of said water, said olive oil, said natural salt, and said soybean paste mixed in said step 1 again and mixing it in a similar manner to that in said step 4;
7) repeating this three more times to mix the whole amount of said water, said olive oil, said natural salt, and said soybean paste mixed in said step 1;
8) clumping a ball consisting of said water and said powder gradually made together into a big ball by hands;
9) pressing it well into a container by hands and leaving it at a temperature of 5° C. or lower overnight to harden it firmly; and
10) cutting it into small pieces, putting them in the oven, and baking them at a temperature of 170° C. for about 17 to 18 minutes.

13. The method for producing a dietary supplement according to claim 12, wherein about 30 to 60 wt. % either a wheat whole grain or a rye whole grain or both, about 1 to 2 wt. % said whole fish, about 8 to 28 wt. % seed, about 0.6 to 1.2 wt. % said natural salt, about 5 to 12 wt. % said olive oil, and about 7 to 16 wt. % said soybean paste are mixed.

14. The method for producing a dietary supplement according to claim 13, wherein said seed includes almond powder, pine nuts, walnuts, chopped almonds, and white sesame.

15. The method for producing a dietary supplement according to claim 12, wherein cheese is further comprised.

16. The method for producing a dietary supplement according to claim 15, wherein said cheese includes at least about 6 to 12 wt. % Edam cheese and Gruyere cheese.

17. The method for producing a dietary supplement according to claim 12, wherein about 0.07 wt. % cinnamon and about 0.12 wt. % nutmeg are further comprised.

18. The method for producing a dietary supplement according to claim 12, wherein said whole fish are used as they are without being finely ground.
